(19) United States
(12) Patent Application Publication
(10) Pub. No.: US 2006/0157542 A1
(43) Pub. Date: Jul. 20, 2006

(54) Method for machining a workpiece made from a titanium-based alloy

(76) Inventors: Joachim Rosler, Lammer Heide (DE); Martin Baker, Sandkamp (DE); Carsten Siemers, Braunschweig (DE)

Correspondence Address: GREENBLUM & BERNSTEIN, P.L.C., 1950 ROLAND CLARKE PLACE, RESTON, VA, 20191, US

(21) Appl. No.: 10/562,678

(22) PCT Filed: Jul. 9, 2004
(86) PCT No.: PCT/DE04/01496

§ 371 Date: Feb. 24, 2006

(30) Foreign Application Priority Data
Jul. 11, 2003 (DE) 103 32 078.4

(51) Int. Cl. B23K 35/38; B23K 31/02

(52) U.S. Cl. 228/220; 228/206

(57) ABSTRACT

A method for machining a workpiece made from titanium based alloy is provided. the method comprises: heating the workpiece in a hydrogen containing atmosphere, whereby hydrogen is taken up; cooling the workpiece; metal-removing machining of the workpiece; and heating the workpiece in a hydrogen-free atmosphere, whereby hydrogen is released. A workpiece made by the method is also provided.

The invention relates to a method for machining a workpiece made from a titanium-based alloy.

Titanium and titanium alloys have three characteristic properties which make them technically important: high strength combined with a good ductility, low relative density and good corrosion resistance with respect to oxidizing acids. On account of these favorable combinations of properties, titanium alloys are used inter alia in the aeronautical and aerospace industries, in jet engines and high-performance engines and in the manufacture of chemical equipment.

A typical alloy is TiAl6V4 with a tensile strength of 900-1200 N/mm² at an elongation at break of approximately 10%. In the aeronautical and aerospace industry, this popular titanium material is used for compressor blades, rivets, screws, through selector shafts, selector cells, drive shafts, transmission parts, rotor heads, to fuel tanks and combustion chamber housings.

Titanium and its alloys are ductile and difficult to machine, which means that it is only possible to achieve cutting speeds corresponding to approximately one 20th of the cutting speeds which can be achieved with unalloyed steel.

To achieve a better efficiency or higher power in large diesel engines, as are used for example for ships or locomotives, the air which flows in is pre-compressed by a turbocharger. The turbocharger compressor wheels are in this case generally made from aluminum alloys. If the efficiency of the engines is to be improved further, the compression ratio needs to be increased still further. On account of the even more strongly heated compressed air, high compression ratios then cause high temperatures at the compressor wheels. On account of their hot strength being too low, aluminum alloys are no longer suitable for use in turbochargers of this type. For this reason, TiAl6V4 is used. However, the poor machineability represents a major problem and drastically increases the manufacturing costs, which has to be accepted.

The compressor wheels have a diameter of up to 2 m. To produce them, a blank is forged from an ingot of material. The final contour of the compressor blades is machined out of the blank by metal-removing machining using a milling process. The machining time for the workpiece made from the titanium alloy is approximately 10 times that of an aluminum workpiece. Therefore, a high proportion of the production costs are attributable to the machining operation.

Moreover, the high cutting forces impose very high thermal stresses on the machining tools, which means that these tools are subject to high levels of wear.

Working on the basis of this problem, it is intended to provide a method and an alloy for machining a workpiece made from a titanium-based alloy, in particular from TiAl6V4, which allows higher cutting speeds to be achieved.

To solve this problem, the method is distinguished by the following steps:
a) heating of the workpiece in a hydrogen-containing atmosphere, during which step the workpiece takes up hydrogen;
b) cooling of the workpiece;
c) metal-removing machining of the workpiece;
d) heating of the workpiece in a hydrogen-free atmosphere, in particular in vacuo during which step hydrogen is released.

The hydrogen atoms which diffuse into the workpiece provide the material with good machining properties. In particular at high cutting speeds, the cutting force decreases by over 50% compared to the conventional titanium alloy. When the workpiece is heated again in vacuo after the machining, the hydrogen atoms diffuse back out of the material and the original ductility is restored.

The production costs are drastically reduced on account of the shorter machining time, in particular for large components. Tool wear is also reduced. Initial tests showed a reduction of 15%. It has emerged in particular that the reduction in the cutting force is greater at higher cutting speeds than at low cutting speeds.

To take up the hydrogen, the workpiece is preferably heated to 973 K. The subsequent cooling takes place in the deactivated annealing furnace. After the cooling, the hydrogen concentration in the workpiece should be less than 1.5% by weight of hydrogen (H) in titanium (Ti).

The hydrogen-containing atmosphere in the annealing furnace is under a pressure of 5·10³ Pa. This corresponds to an equilibrium concentration of approximately 0.5% by weight of hydrogen in titanium.

The annealing time is in principle dependent on the component geometry. However, it is at least 2 hours in the hydrogen-containing atmosphere.

It is preferable for the workpiece to remain exposed to the hydrogen-containing atmosphere during the cooling step as well.

To enable the hydrogen to diffuse back out of the workpiece as quickly as possible, the vacuum preferably amounts to 2·10⁻³ Pa. The annealing temperature in the vacuum is preferably once again 973 K.

The heating of the workpiece is particularly preferably carried out inductively. Surface oxides and/or further covering layers are removed from the workpiece prior to heating, at least in the regions which are subsequently to undergo metal-removing machining. It is preferable for surface oxides or covering layers to be removed by means of an etching solution, which particularly preferably consists of a mixture of H₂O, HNO₃ and HF together with H₂O₂.

Lanthanum can be admixed with the titanium-based alloy, in particular the TiAl6V4-based alloy, in which case the lanthanum content is 0.3-3 atomic %.

It is also possible for small quantities of cerium to be added to the titanium-based alloy.

Surprisingly, it has emerged that a titanium-based alloy to which lanthanum has been admixed is distinguished by an increased thermal conductivity, which reduces the frictional heat generated during machining. Consequently, higher machining speeds can be realized for workpieces made from a titanium-based alloy with admixed lanthanum than for workpieces made from a previously known titanium-based alloy. These higher cutting speeds become achievable without the workpiece being laden with hydrogen prior to machining.

An exemplary embodiment of the invention is to be explained in more detail below with reference to the appended figures, in which:

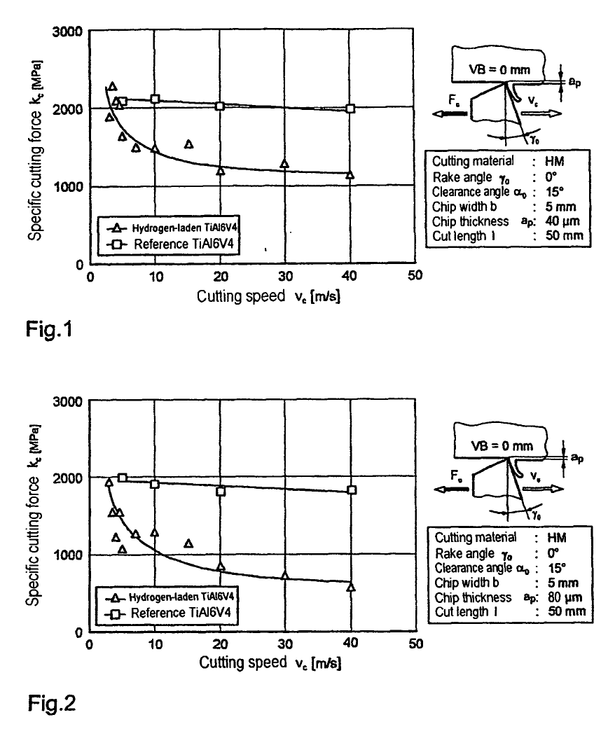

FIG. 1 shows a comparison of the cutting force curve between conventional TiAl6V4 and hydrogen-laden TiAl6V4 with a chip thickness of 40 μm,

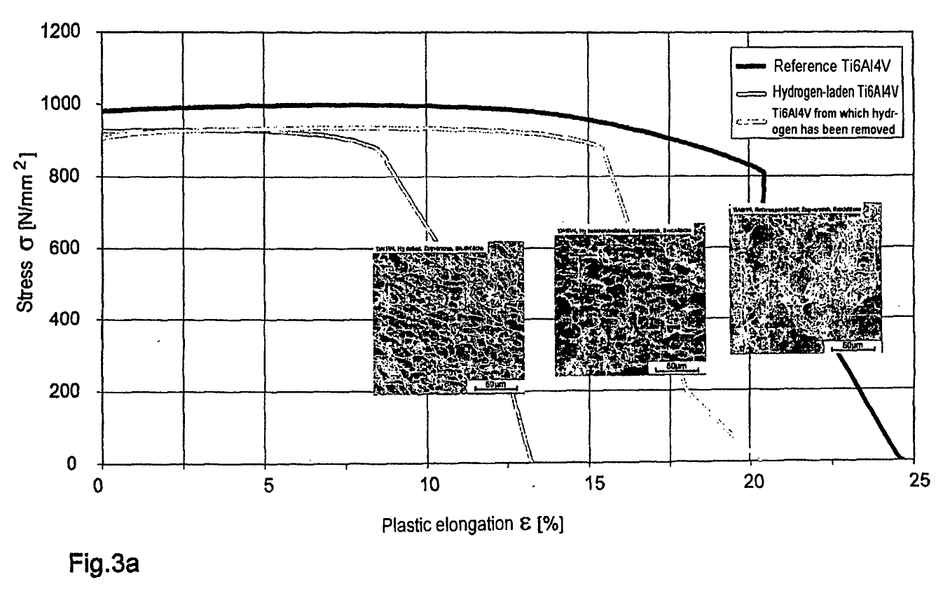

FIG. 2 shows a comparison of the cutting force curve between conventional TiAl6V4 and hydrogen-laden TiAl6V4 with a chip thickness of 80 μm,

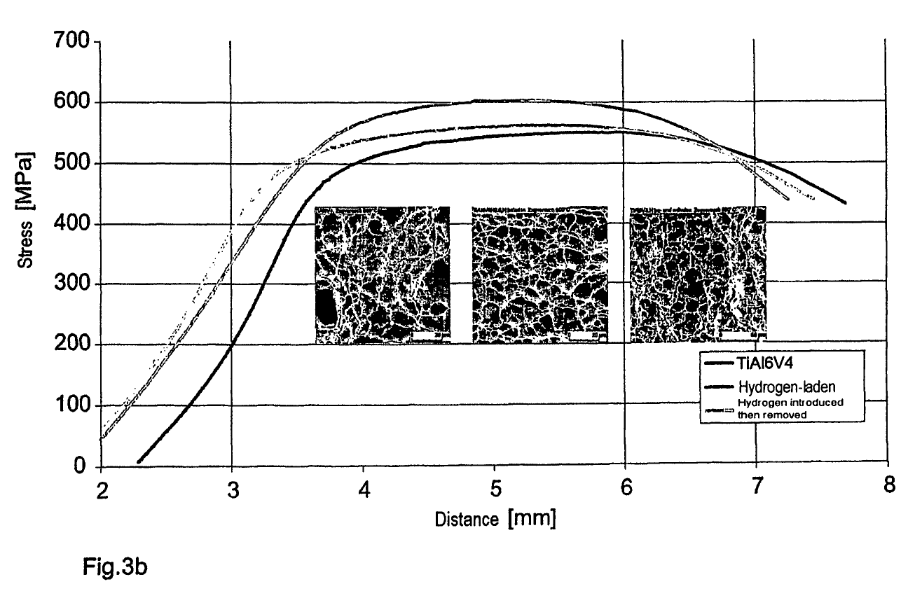

FIG. 3a shows the tensile test diagram between TiAl6V4, hydrogen-laden TiAl6V4 and TiAl6V4 from which hydrogen has been removed again at 293 K,

FIG. 3b shows the tensile test diagram between TiAl6V4, hydrogen-laden TiAl6V4 and TiAl6V4 from which hydrogen has been removed again at 773 K,

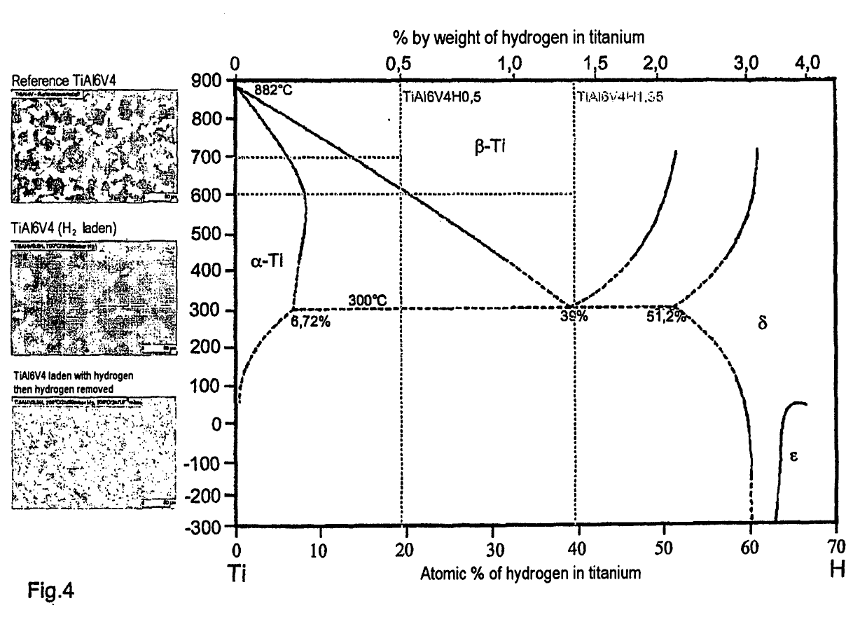

FIG. 4 shows the titanium-hydrogen phase diagram,

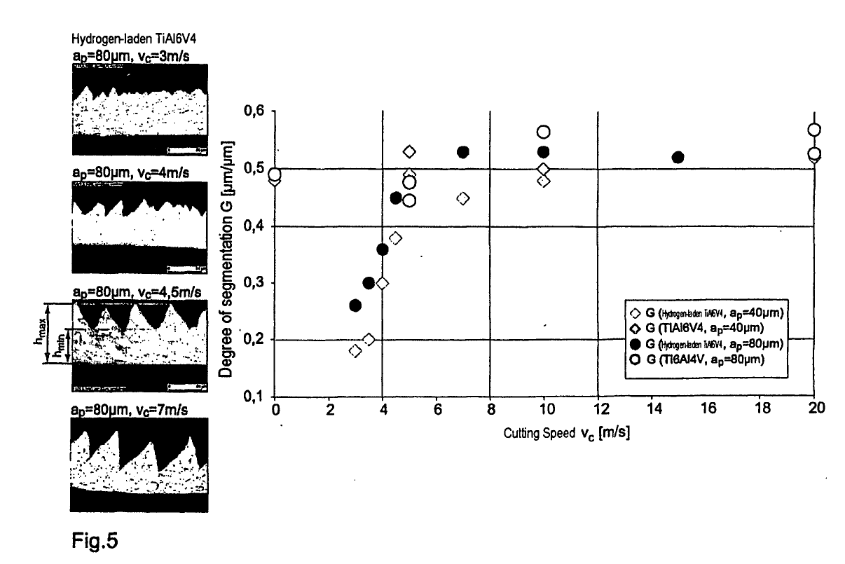

FIG. 5 shows a diagram for chip analysis,

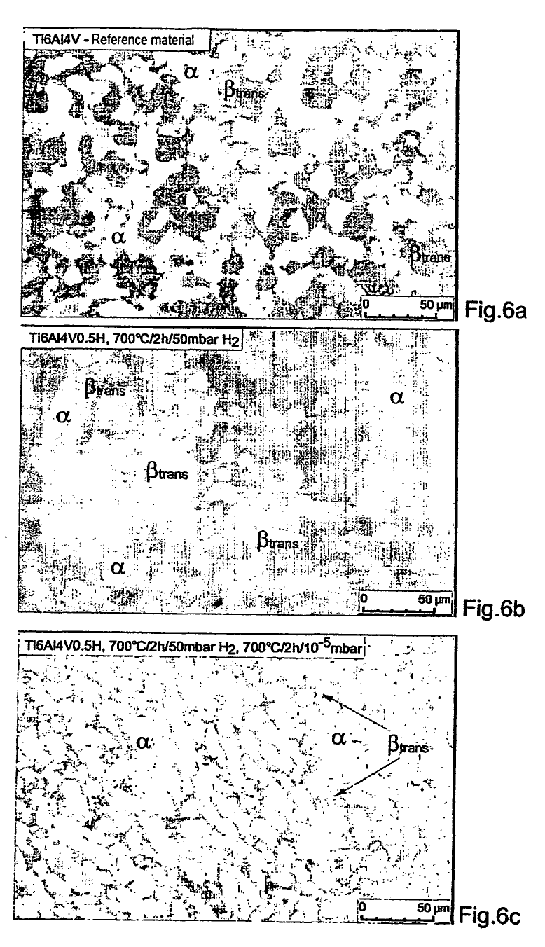

FIG. 6a shows a microstructural analysis of TiAl6V4,

FIG. 6b shows a microstructural analysis for hydrogen-laden TiAl6V4,

FIG. 6c shows a microstructural analysis for TiAl6V4 from which hydrogen has been removed again,

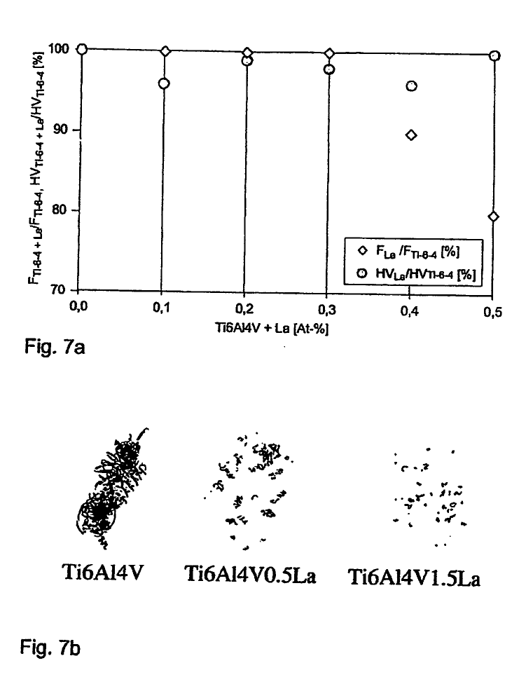

FIG. 7a shows the curve of the cutting force and the hardness of TiAl6V4 as a function of the lanthanum content,

FIG. 7b shows the various chip shapes of TiAlV64 as a function of the lanthanum content.

The titanium-based alloy TiAl6V4 is produced in the conventional way, i.e. casting, forging, and the required heat treatments are carried out in accordance with the prior art, so as to form a material with a duplex microstructure and high tensile strengths combined with good ductility, and after production of the blank from this alloy, this blank can be deformed in the conventional way.

Prior to the metal-removing machining of the workpiece, the alloy is cleaned, either completely or only in the regions which are to be machined, with an etching solution, which consists for example of 50 ml of H₂O, 50 ml of HNO₃, 10 ml of the solution [12 ml of HF+70 ml of H₂O₂] for 5-10 minutes, so that surface oxides and any covering layers are removed from the workpiece surface. Then, the workpiece is heated to a temperature of 973 K (700° C.) in an induction furnace, in which there is a hydrogen-containing atmosphere at a pressure of 5·10³ Pa, and annealed for at least 2 hours, with the result that hydrogen atoms diffuse into the workpiece and accumulate in the base material. The rate at which hydrogen diffuses into titanium is high compared to other metals. At 973 K it is approximately 0.1 mm/min. This means that after an annealing time of 1 hour, a penetration depth of hydrogen into the titanium workpiece of 6 mm is to be expected. The penetration depth rises with increasing temperature. Since the volume to be machined is known, the loading time can be adapted accordingly, so that only those regions which are to be machined are enriched with hydrogen. The annealing time is fundamentally dependent on the component geometry. The larger the regions of the components to be machined, the longer the workpiece has to be annealed. After cooling, the hydrogen concentration in the workpiece should be 0.5% by weight in the titanium.

For cooling, the induction furnace is switched off and the workpiece is left to its own devices. When it has reached a temperature which allows further processing, the hydrogen-laden workpiece is subjected to metal-removing machining. FIG. 5 shows the degree of segmentation G plotted against the cutting speed v_{c} for a hydrogen-laden material and a material which is not laden with hydrogen, with a chip thickness aₚ of 40 μm and 80 μm.

The degree of segmentation is determined according to the following formula:

$$G = \frac{{h}_{max} - {h}_{min}}{{h}_{max}}$$

in which for 0<G<0.3 a continuous chip is present, at G≈0.3 a transition chip is present and at G>0.3 a segment chip is present.

It can be seen from the left-hand part of FIG. 5 that after the material has been laden with hydrogen, during machining a transition from a continuous chip to a segment chip is established as a function of the cutting speed; this transition can also be observed, for example, when machining steels and aluminum alloys but not when machining TiAl6V4 which has not been laden with hydrogen.

Segment chips have a saw-blade-like appearance, whereas continuous chips are chips with a constant cross section over the length of the chip.

After the machining operation, the workpiece is etched again and then annealed. This time, a vacuum of 2·10⁻³ Pa is applied. The workpiece is annealed again at 773 K to enable the hydrogen atoms to diffuse out of the workpiece again, resulting in the original ductility of the workpiece being restored. If the ductility of the hydrogen-laden workpiece, under exceptional circumstances, is sufficiently high for the intended use, it is possible to dispense with the further annealing step after machining.

As shown in FIGS. 3a and 3b, the demands imposed on the strength and ductility of the material are satisfied by the modified alloy at room temperature (293 K) and at 973 K. The strength achieved by the hydrogen-laden specimens was within the fluctuation range, which is dependent on the a phase content, of various duplex microstructures. As FIG. 3a shows, loading the material (workpiece) with hydrogen leads, with a decrease in strength by approximately 8%, to a reduction in the elongation at break which results in a decreasing elongation at break from 20% to 8%. On account of the subsequent operation of removing hydrogen again, it is possible, while retaining the same strength, to increase the ductility back to approximately 16%, i.e. considerably. All three materials have a ductile fracture behavior with a honeycomb-like fracture surface. A considerable reduction of area at fracture was observed on the specimens.

It can be seen from FIG. 3b that the strength of the hydrogen-laden specimen is slightly higher than the reference specimen at 773 K (500° C.), which can be explained by an increased diffusion rate of the hydrogen into titanium at this temperature, so that the dislocation motion is impeded. On the other hand, no differences can be measured in terms of the elongation at break.

Hydrogen is known to stabilize the body-centered cubic β phase in titanium. Accordingly, as per the Ti—H phase diagram illustrated in FIG. 4, the phase transformation α→β is shifted toward lower temperatures by adding hydrogen to the alloy, so that during a heat treatment at 700° C. (973 K) in a hydrogen-containing atmosphere, transformation to a pure β titanium microstructure would be likely. Heat treatments in the single-phase field generally lead to a coarse-grained microstructure. A microstructural analysis is carried out on three different specimens. FIGS. 6a to 6c show that there is no undesirable change in microstructure as a result of grain growth, i.e. altogether surprisingly there is evidently no single-phase β titanium after the doping. This is probably attributable to the action of the alloying element aluminum as an a stabilizer. A coarse-grained microstructure would have a considerable adverse effect on the mechanical properties of the material. According to the invention, however, the stability of the microstructure is ensured.

Lanthanum could be admixed with the titanium-based alloy, in particular the alloy TiAl6V4, in an amount of from 0.3 to 3 atomic %. Up to a lanthanum content of 1.5 atomic %, the lanthanum is completely precipitated in the basic microstructure. The particles have a mean size of 12 μm. The distribution of the lanthanum precipitates is restricted to the grain boundaries and the grain interior between the dendrites of the cast microstructure. Tests have shown that the precipitates are identified as virtually pure lanthanum. Oxygen or nitrogen are not detected. At lanthanum contents above 2 atomic %, a second phase is formed in addition to the lanthanum precipitates. The microstructure of the second phase comprises a lanthanum matrix (80% of the microstructure) with meandering titanium inclusions (approximately 20%). Aluminum or vanadium are not detectable. A virtually uniform appearance of the microstructure can be achieved if cerium is admixed with the alloy instead of lanthanum.

The alloy TiAl6V4 with lanthanum is produced in a vacuum arc furnace. The conventional TiAl6V4 alloy is used as prealloy and is introduced into the furnace together with elemental lanthanum as a block. Prior to melting, first of all a vacuum of, for example, 10⁻³ Pa is generated in order to remove oxygen from the furnace chamber. The operation of striking the arc then takes place at approx. 6·10⁴ Pa in the furnace chamber. Since titanium can only dissolve very small quantities of lanthanum at room temperature, producing the alloy gives a microstructure made up of TiAl6V4 with discrete precipitations of lanthanum particles. Prior to melting down, the oxide layer in the lanthanum block has to be removed. This is done, for example, mechanically using a file with subsequent cleaning and storage in alcohol or acetone until the lanthanum is introduced into the furnace. When the alloy is being melted, it is surprisingly found that the thermal conductivity of the lanthanum-containing alloy rises compared to the standard alloy, since the melt cools down significantly more quickly than the alloy without added lanthanum. To ensure that the alloy is capable of industrial application, the alloy has to be thermo-mechanically treated in order to produce a duplex microstructure. For this purpose, the alloy can be deformed, for example by extrusion, in a temperature range between 973 K and 1023 K. In the extruded state, this alloy achieves a tensile strength of approximately 1000 N/mm² and is therefore comparable to the base alloy TiAl6V4.

As FIG. 7a shows, the cutting force is reduced as a function of the lanthanum content. This starts from a lanthanum content of 0.3 atomic % and reduces the cutting force by 20% at a lanthanum content of 0.5 atomic %. As the figure also shows, there is scarcely any change to the hardness of the material as a result of the addition of lanthanum to the alloy.

FIG. 7b shows that a ribbon or snarl chip is formed when machining TiAl6V4 without added lanthanum. The addition of lanthanum to the alloy results in short-breaking chips during machining, as are known for example from free-machining steels but not for TiAl6V4. This can be explained by the presence of the lanthanum particles in the microstructure. The short-breaking chip has the advantage of reducing the contact surface area and therefore the contact time between chip and cutting surface of the tool, with the result that the frictional heat generated in the contact zone is considerably reduced. The increased thermal conductivity means that the frictional heat that is generated is dissipated into the chip to a significantly greater extent than in the case of TiAl6V4, with the result that the thermal stressing of the tool is reduced and therefore its service life is increased, which reduces machining costs.

1. A method for machining a workpiece made from a titanium-based alloy, comprising:
a) heating of the workpiece in a hydrogen-containing atmosphere, wherein the workpiece takes up hydrogen;
b) cooling of the workpiece;
c) metal-removing machining of the workpiece;
d) heating of the workpiece in a hydrogen-free atmosphere, wherein hydrogen is released.

2. The method as claimed in claim 1, wherein the workpiece is heated in a vacuum in order for hydrogen to be released.

3. The method as claimed in claim 1, wherein the workpiece is heated to approximately 973 K for hydrogen to be taken up.

4. The method as claimed in claim 1, wherein the hydrogen-containing atmosphere is under a pressure of approximately 5·10³ Pa.

5. The method as claimed in claim 1, wherein an annealing time in the hydrogen-containing atmosphere is at least 2 hours.

6. The method as claimed in claim 1, wherein the workpiece is cooled in the hydrogen-containing atmosphere.

7. The method as claimed in claim 2, wherein the vacuum is at least 2·10⁻³ Pa.

8. The method as claimed in claim 1 wherein an annealing temperature in the hydrogen-free atmosphere is at least 773 K.

9. The method as claimed in claim 1, wherein the heating is carried out inductively.

10. The method as claimed in claim 1, wherein a hydrogen concentration in the workpiece after cooling is less than 1.5% by weight in titanium.

11. The method as claimed in claim 10, wherein the hydrogen concentration is 0.5% by weight.

12. The method as claimed in claim 1, wherein at least one of surface oxides and further covering layers are removed from the workpiece prior to the heating.

13. The method as claimed in claim 12, wherein the at least one of surface oxides and further covering layers are removed by an etching solution.

14. The method as claimed in claim 13, wherein the etching solution is a mixture comprising H₂O, HNO₃, HF and H₂O₂.

15. The method as claimed in claim 14, wherein the etching solution is a mixture of 50 ml of H₂O, 50 ml of HNO₃, and 10 ml of a solution of [12 ml of HF+70 ml of H₂O₂].

16. A workpiece for use in the method as claimed in claim 1, comprising TiAl6V4.

17. The workpiece as claimed in claim 16, wherein lanthanum is admixed with the TiAl6V4.

18. The workpiece as claimed in claim 17, wherein a lanthanum content amounts to 0.3-3 atomic %.

19. The workpiece as claimed in claim 16, wherein cerium is admixed with the TiAl6V4.

20. The workpiece as claimed in claim 19, wherein a cerium content is less than 3 atomic %.

21. An alloy for producing a workpiece made from a titanium-based alloy, comprising a lanthanum content of 0.3-3 atomic %.
